(19) United States
(12) Patent Application Publication
(10) Pub. No.: US 2012/0043748 A1
(43) Pub. Date: Feb. 23, 2012

(54) Inlaid Ornamental Relief of Book Covers

(76) Inventor: Chun-Mu Huang, Tainan (TW)

(21) Appl. No.: 12/861,092

(22) Filed: Aug. 23, 2010

(51) Int. Cl. B42D 15/00

(52) U.S. Cl. 283/64

(57) ABSTRACT

An inlaid ornamental relief of book covers includes an inner cover sheet, a tray, an ornamental relief, a transparent panel and an outer cover board. The tray is glued on the inner cover sheet, provided with a printed ornamental picture. The ornamental relief is fixedly positioned on the ornamental picture of the tray. The transparent panel is combined on the tray, provided with a projection corresponding to the ornamental relief so that the ornamental relief can be restrictively positioned between the tray and the transparent panel. The outer cover board is combined on the inner cover sheet. So can the book cover be seen in a 3-dimentional condition.

### BACKGROUND OF THE INVENTION

1. Field of the Invention

This invention relates to an inlaid ornamental relief of book covers, particularly to one with a 3-dimentional condition.

2. Description of the Prior Art

Commonly, conventional book covers are mostly designed with flat printing, depicted with a mark or an ornament, looking too monotonic.

### SUMMARY OF THE INVENTION

The object of this invention is to offer an inlaid ornamental relief of book covers, so as to make the book covers look livelier and more vivid than the conventional one.

The main characteristics of the invention are an inner cover sheet, a tray, an ornamental relief, a transparent panel and an outer cover board. The tray is glued on the inner cover sheet, provided with a printed ornamental picture. The ornamental relief is fixedly positioned on the ornamental picture of the tray. The transparent panel is combined on the tray, provided with a projection corresponding to the ornamental relief so that the ornamental relief can be restrictively positioned between the tray and the transparent panel. The outer cover board is combined on the inner cover sheet. So can the book cover of the invention be seen in a 3-dimentional condition.

### BRIEF DESCRIPTION OF DRAWINGS

This invention is better understood by referring to the accompanying drawings, wherein:

FIG. 1 is an exploded perspective view of a first preferred embodiment of an inlaid ornamental relief of book covers in the present invention;

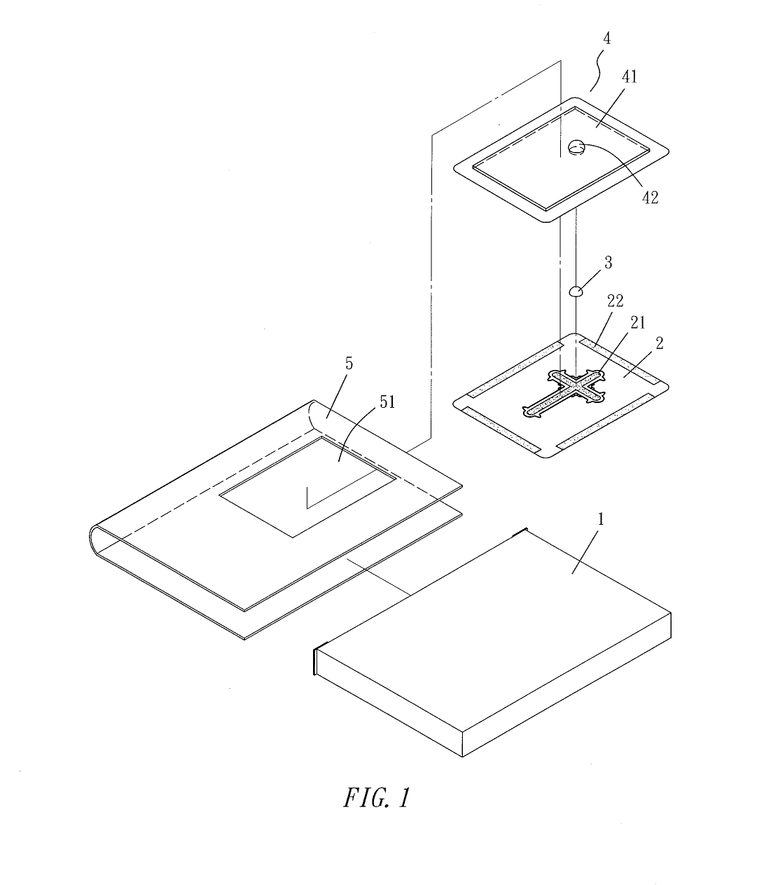

FIG. 2 is a perspective view of the first preferred embodiment of an inlaid ornamental relief of book covers in the present invention;

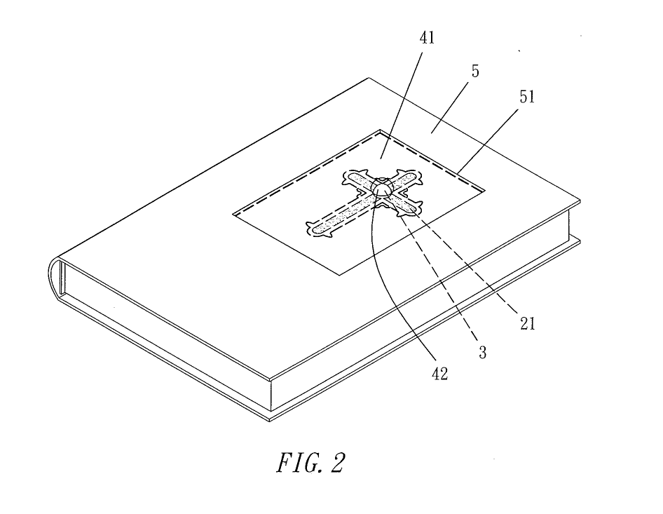

FIG. 3 is a partial magnified cross-sectional view of the first preferred embodiment of an inlaid ornamental relief of book covers in the present invention;

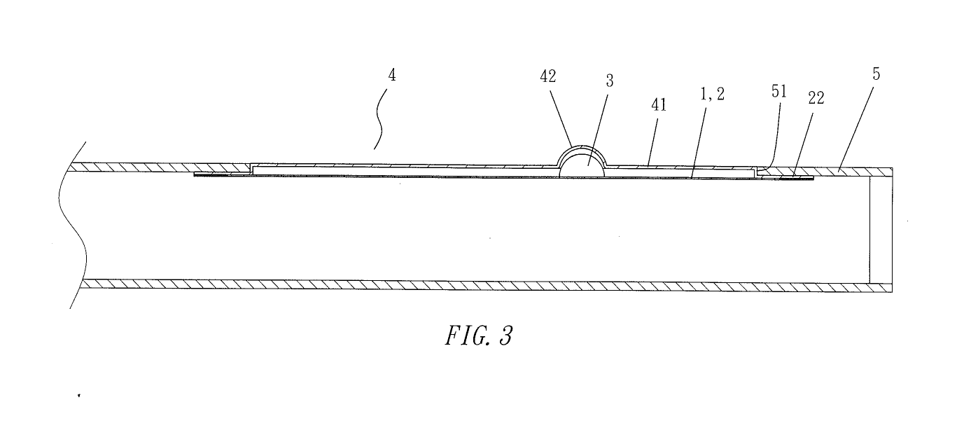

FIG. 4 is a perspective view of a second preferred embodiment of an inlaid ornamental relief of book covers in the present invention; and

FIG. 5 is a partial magnified cross-sectional view of the second preferred embodiment of an inlaid ornamental relief of book covers in the present invention.

### DETAILED DESCRIPTION OF THE PREFERRED EMBODIMENT

A bible cover is used as an example of the embodiments in the present invention.

As shown in FIGS. ˜3, a first preferred embodiment of an inlaid ornamental relief of book covers in the present invention includes an inner cover sheet 1, a tray 2, an ornamental relief 3, a transparent 5 panel 4 and an outer cover board 5.

The inner cover sheet 1 is a first page of a book.

The tray 2 is glued on the inner cover sheet 1, provided with a printed ornamental picture 21, like a cross, and a double-sided adhesive tape 22 stuck 10 around the circumference.

The ornamental relief 3 is formed granular, fixedly glued on the cross intersection of the ornamental picture 21. In this embodiment, the ornamental relief is composed of a single member.

The transparent panel 4 is combined with the tray 2 by means of the double-sided adhesive tape 22, provided with a projected portion 41 and a projection 42 formed on the projected portion 41 to correspond to the ornamental relief 3, so that the ornamental relief 3 can be restrictively positioned between the tray 2 and the transparent panel 4.

The outer cover board 5 is provided with an open window 51 employed to accommodate the projected portion 41 of the transparent panel 4, able to be glued together with the inner cover sheet 1 to become a deluxe cover.

With the ornamental relief 3 confined between the tray 2 and the projection 42 of the transparent panel 4, the cross ornamental picture 21 of the tray 2 and the ornamental relief 3 can be clearly seen in a 3D condition much more vivid than the conventional ones.

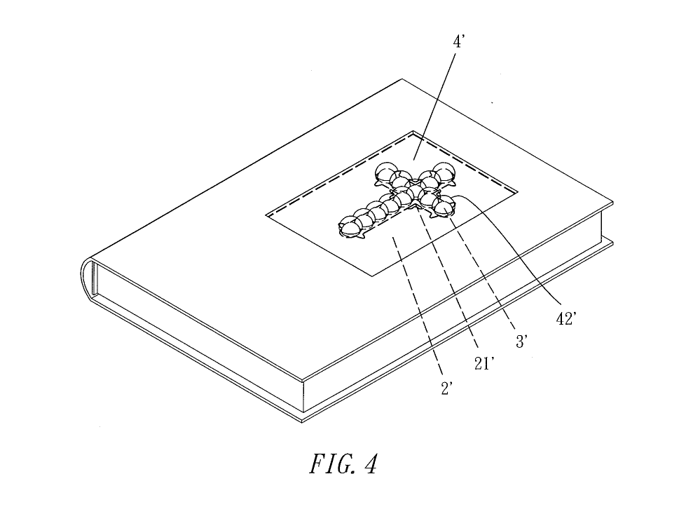

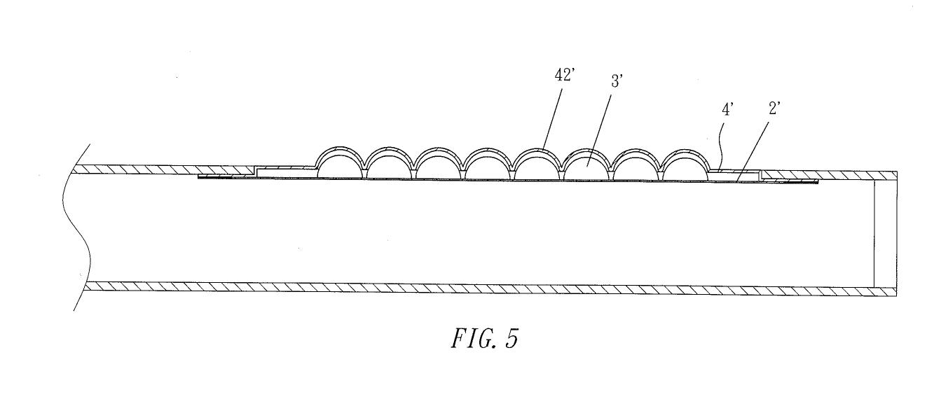

Furthermore, as shown in FIGS. 4 and 5, a second preferred embodiment of an inlaid ornamental relief of book covers in the present invention includes an inner cover sheet 1, a tray 2′, an ornamental relief 3′, a transparent panel 4′ and an outer cover board 5. The 10 ornamental relief 3′ is composed of a plurality of granular members arrayed on a cross ornamental picture 21′ of the tray 2′. The transparent panel 4′ is provided with plural projections consecutively protruded to shape as a cross to correspond to the ornamental relief 3′, so that the ornamental relief 3′ can be restricted between the tray 2′ and the transparent panel 4′.

While the preferred embodiment of the invention has been described above, it will be recognized and understood that various modifications may be made therein and the appended claims are intended to cover all such modifications that may fall within the spirit and scope of the invention.

What is claimed is:

1. An inlaid ornamental relief of book covers comprising:
an inner cover sheet;
a tray glued on said inner cover sheet and provided with a printed ornamental picture;
an ornamental relief fixedly positioned on said ornamental picture; and
a transparent panel combined with said tray and provided with a projection corresponding to said ornamental relief so that said ornamental relief can be restrictively positioned between said tray and said transparent panel.

2. The inlaid ornamental relief of book covers as claimed in claim 1, wherein said ornamental picture of said tray is a cross.

3. The inlaid ornamental relief of book covers as claimed in claim 1, wherein said ornamental relief is formed granular.

4. The inlaid ornamental relief of book covers as claimed in claim 1, wherein said ornamental relief is composed of a single member positioned on said ornamental picture of said tray.

5. The inlaid ornamental relief of book covers as claimed in claim 1, wherein said ornamental relief is composed of a plurality of members fixedly arrayed on said ornamental picture of said tray to shape as a cross as said ornamental picture does.

6. The inlaid ornamental relief of book covers as claimed in claim 1, wherein said transparent panel has plural said projections consecutively arrayed to shape as a cross.

7. The inlaid ornamental relief of book covers as claimed in claim 1, wherein said projection is protruded upward from a projected portion of said transparent panel.

8. The inlaid ornamental relief of book covers as claimed in claim 1, wherein an outer cover board is combined with said inner cover sheet and provided with an open window.
